(19) United States
(12) Patent Application Publication
(10) Pub. No.: US 2015/0030752 A1
(43) Pub. Date: Jan. 29, 2015

(54) Biomass feed and fuel pellets

(71) Applicant: Riverside Fuels LLC, Plover, WI (US)

(72) Inventors: Andrew Joseph Omernik, Stevens Point, WI (US); Michael Gregory Omernik, Stevens Point, WI (US); Erik Scott Omernik, Stevens Point, WI (US)

(73) Assignee: Riverside Fuels LLC, Plover, WI (US)

(21) Appl. No.: 13/952,041

(22) Filed: Jul. 26, 2013

(51) Int. Cl. C10L 5/44; A23K 1/14

(52) U.S. Cl. CPC C10L 5/445; A23K 1/14
USPC 426/630; 44/589

(57) ABSTRACT

Pellet compositions derived from agricultural combustible biomass and oil-retaining seed mash are described. A lubricant such as glycerol or glycerin may also be included to increase pelletability and increase the BTU/lb of the pellets. The components used for making the pellets are byproducts of biofuel production and typically have little economic value. Pellet composition advantageously include the use on material derived from Camelina plants as the combustible biomass and seed mash. Methods of making the pellets are also disclosed.

### FIELD

This description relates to biomass pellets and more specifically to biomass pellets for animal feed and fuel.

### BACKGROUND

A number of industries use agricultural biomass as an alternative to hardwood fuels or petroleum/fossil fuels. In recent years, there has been a dramatic inflation in the production of biofuels given governmental support for biofuel production as well as high fossil fuel costs. Increasing costs and environmental concerns related to fossil fuels have also led to an increased demand for alternative fuels.

The use of agricultural biomass in biofuels generates a number of byproducts. One byproduct of the biofuel production process is glycerine or glycerol, which has a negligible economic value in the sense of production use. Another byproduct of the biofuel process lies in the field stover of various oilseed crops, which is usually tilled into the soil and has little supplementary use, but can be baled for livestock feed during lean seasons. The last byproduct of the biofuel process is the pressed seed mash which contains oil and is therefore a viable livestock feed source, but is still produced in limited quantities and cannot fully sustain a livestock operation.

Camelina is a native plant from Finland to Romania and east to the Ural Mountains and was first cultivated in northern Europe during the Bronze Age. In recent years, Camelina production has increased in the United States due to heightened interest in vegetable oils high in omega-3 fatty acids. These fatty acids are abundant in Camelina oil. Camelina can be grown with few input costs and under marginal conditions.

### SUMMARY

In one aspect, the present description relates to a composition of pellets wherein the pellets comprise a pelletizable mixture and a lubricant wherein the pelletizable mixture comprises combustible biomass and an oil-retaining seed mash, the pellitizable mixture comprising material derived from Camelina.

In another aspect, the present description relates to a method for preparing a composition of pellets. The method includes forming a pelletizable mixture from combustible biomass and oil-retaining seed mash wherein the pelletizable mixture comprises material derived from Camelina. The method also includes adding lubricant to the pelletizable mixture, drying the mixture and pelleting the dried product to form a composition of pellets.

In a further aspect, the present description relates to a method for using byproducts from the production of biofuels. The method includes forming a pelletizable mixture from combustible biomass and oil-retaining seed mash wherein the pelletizable mixture comprises material derived from Camelina. The method also includes adding lubricant to the pelletizable mixture, drying the mixture and pelleting the dried product to form a composition of pellets.

### DETAILED DESCRIPTION OF ILLUSTRATIVE EMBODIMENTS

The present description relates to the use of byproducts generated by the production of biofuels from agricultural biomass. The byproducts can be used to generate pellets that can be used as fuel and/or as animal feed. The pellets include field stover and seed mash of oilseed crops in addition to measured inclusion of glycerin and/or glycerol in order to increase the BTU output. The pellets generated in the present description have a superior BTU yield than a conventional wood pellet and are more economical than creating pellets solely from crop sources.

In preferred embodiments, the pellets include pelletizable mixture that includes combustible biomass material and oil-retaining seed mash byproduct material. Optionally, a combustible lubricant such as glycerol and/or glycerin is added to the pelletizable mixture. Advantageously, the combination of these components in ratios described herein can result in a commercially viable product that has superior BTU/lb of pellet. Furthermore, due to the natural crop matter required for the mixture, the pellets that are created can be used as a livestock feed pellet.

In more preferred embodiments, the relative proportions of the components in the pellets include about 40% to about 90%, by weight, of the combustible biomass material, from about 10% to about 40%, by weight, of the oil-retaining seed mash byproduct material and from about 0% to about 30%, by weight, of a combustible glycerol or glycerin lubricant.

Camelina as used herein can relate to any species of the Camelina plant and generally includes Camelina plants with high oil content. In some preferred embodiments, Camelina derived combustible biomass and/or Camelina derived oil-retaining seed mash is from Camelina sativa. Material-derived from a plant as used herein relates to any plant material including roots, stalks, stover, leaves, seed, seed mash and the like. “Material-derived from Camelina” as used herein relates to any Camelina plant material including roots, stalks, stover, leaves, seed, seed mash and the like

The combustible biomass material can be from a variety of sources including, for example, field stover such as soybean stover, camelina stover, canola stover, field or sweet corn stalks and the like. The combustible biomass material can include material from one source such as camelina stover. Alternatively, it can include a combination of one or more materials. In one preferred embodiment, the combustible biomass includes camelina stover. In another preferred embodiment, the combustible biomass includes a processed blend of field stover from camelina stover and combinations of other related field stovers wherein the primary ingredient is a product of Camelina.

The oil-retaining seed mash can be a byproduct material from the production of biofuels. The oil-retaining seed mash can be obtained during the seed pressing process. Generally, in seed pressing the oil is pressed from the seed. However, a significant amount of oil can be retained in the seed mash.

The oil-retaining seed mash can include seed mash that is derived from a number of sources including Camelina, canola, oil palm, Rapeseed, Castor Beans, Soybeans, Jatropha, Crambe, Sunflower, Safflower, Mustard, Peanut, Linseed and the like. The oil-retaining seed mash may also be derived from oil-producing Algae and the like. In preferred embodiments, oil-retaining seed mash includes seed mash from Camelina seeds. The oil-retaining seed mash can be from one source such as Camelina seed mash. Alternatively, the oil-retaining seed mash can include a combination of oil-retaining seed mashes such as Camelina seeds, canola seeds and other oilseeds. The seed mash generally has some residual oil. Preferably, the seed mash has between about 5% to about 15% by total volume of oil.

The pellets may also include one or more lubricants. A variety of lubricants are known and include, for example, glycerin, glycerol, Yellow Grease, Brown Grease, Tallow, and/or Lard. In preferred embodiments, the lubricant includes glycerin and/or glycerol. The pellets may also, optionally include an essential oil. The lubricant present in the pellet can increase the cohesiveness of the pellet in addition to the BTU content. Examples of essential oils include Eucalyptus, Rosemary, Lavender, Sweet Orange, Tangerine, Tea Tree, Grapefruit, Basil and the like. The addition of the essential oil can increase the BTU content of the pellets as well as providing a pleasing fragrance upon burning when the pellets are used as fuel.

The amount of the components described above in the final pellets can vary. In preferred embodiments, the amount of combustible biomass material in the pellets is between about 40% to about 90%, by weight. As described above, this weight of combustible biomass may be derived from the same type of plant, i.e.Camelina stover. Alternatively, the combustible biomass may include material derived from more than one type of plant. In some preferred embodiments, the majority of the combustible biomass is from Camelina stover.

The amount of oil-retaining seed mash in the final pellets can vary. In preferred embodiments, the amount of oil-retaining seed mash is between about 10% to about 40%, by weight. As described above, this weight of oil-retaining seed mash may be derived from the same type of plant, i.e. Camelina seeds. Alternatively, the oil-retaining seed mash may include material derived from more than one type of seed. In some preferred embodiments, the majority of the oil-retaining seed mash is from Camelina seeds.

The amount of lubricant in the final pellets can vary. The final pellets can include lubricant from about 0.01% to about 30%, by weight, of a combustible glycerol or glycerin lubricant. Pellets with no lubricants are also within the scope of this invention. When included, the amount of essential oil preferably does not exceed about 10% of the lubricants allotted volume by weight.

The pellets described herein can be used for multiple purposes. The pellets may be used as fuel pellets and burned in stoves, fireplaces and the like. They may be used alone or combined with other combustible material such as other fuel pellets, logs and the like. The combination of the combustible biomass supplemented with oil-retaining seed mash and optionally, the lubricant can provide a superior BTU per pound compared to fuel pellets made from combustible biomass only. Furthermore, the components used in making the pellets are byproducts of the biofuel production process and are fairly economical to use resulting in lower cost per BTU generated. Camelina, for example, requires 8 inches of water during the plant's lifecycle whereas soybeans require 19 inches. Camelina can use less than half of the resources per BTU generated than resources needed to generate BTUs from soybeans. The pellets described herein generate at least about 10,000 BTU per pound, preferably, the pellets can generate at least about 11,000 BTU per pound, more preferably, at least about 12,000 BTU per pound and even more preferably, at least about 13,000 BTU per pound.

The pellets described herein may also be used as animal feed pellets since the pellets include natural crop matter. The pellets may be used directly to feed animals. Alternatively, they may be used as a supplement or added into other animal feed.

The present description also includes a method of preparing a composition of the pellets. The method can include processing the combustible biomass. The combustible biomass material can be processed in order to increase its pelletability and by extension, its BTU content. Processing includes but is not limited to milling the stover or stalks into fine particulates as well as larger (up to about ½ inch) pieces. Preferably, the processing of the combustible biomass results in pieces about ½ inch or less and more preferably, about ¼ inch or less. Pieces larger than ½ inch are also within the scope of the invention. A variety of methods can be used to process the stover and include, for example, the methods described in U.S. Patent Application Publication US2012/0107472A1, incorporated herein by reference.

The method also includes extruding the oil-retaining seed mash. This seed mash can be extruded in a variety of shapes depending on the design of the seed press, but the most common shape is a cylindrical hard tube. Other extruded shapes are also within the scope of this invention. Extruded pieces of seed mash can be processed by running them through a mill and breaking apart the extruded pieces into smaller pieces that can be combined with the processed combustible biomass to form a pelletizable mixture. The combustible glycerol or glycerin lubricant can be added to the pelletizable mixture in a ratio that assists with pelletability. The final mixture may then be treated through a drying cycle until the mixture reaches a range of moisture between about 10% and about 20% moisture by weight. This final, processed and dried mixture may be processed through a pellet mill to create the final pellet product.

A variety of pellet mills may be used and all are within the scope of this invention. Two exemplary types of pellet mills used in this process include a flat die mill and a ring die mill. A flat die mill can take feedstock fed from the top onto the die where two rollers evenly distribute the feedstock and press it through the die. Two cutters on the bottom side of the die can then cut the feedstock at predetermined lengths. A ring die mill can operate under a similar principle but the die is on the outside and the press wheels press outward instead of down. A similar cutting concept operations on the exterior of the ring die mill.

The present description also relates to a method of using byproducts from the production of biofuels. The method includes using the combustible biomass, the oil-retaining seed mash and a lubricant to generate a pelleted product as described above.

Although the present invention has been described with reference to preferred embodiments, workers skilled in the art will recognize that changes may be made in form and detail without departing from the spirit and scope of the invention.

What is claimed is:

1. A composition of pellets wherein the pellets comprise a pelletizable mixture and a lubricant wherein the pellitizable mixture comprises combustible biomass and an oil-retaining seed mash, the pellitizable mixture comprising material derived from Camelina.

2. The composition of claim 1 wherein the lubricant is glycerol, glycerin or combination thereof.

3. The composition of claim 1 wherein the combustible biomass comprises Camelina stover.

4. The composition of claim 1 wherein the oil-retaining seed mash comprises Camelina seed mash.

5. The composition of claim 3 wherein the combustible biomass further comprises soybean stover, corn stover, canola stover and combinations thereof.

6. The composition of claim 4 wherein the oil-retaining seed mash further comprises canola seed mash.

7. The composition of claim 1 wherein the combustible biomass is between about 40% and about 90% by weight of the pellet.

8. The composition of claim 1 wherein the oil-retaining seed mash is between about 10% and about 40% by weight of the pellet.

9. The composition of claim 1 wherein the lubricant is between about 0.01% and about 30% by weight.

10. The composition of claim 1 further comprising an essential oil.

11. The composition of claim 1 wherein the pellet has a moisture content of between about 10% and about 20% by weight.

12. The composition of claim 1 wherein the pellets are fuel pellets.

13. The composition of claim 1 wherein the pellets are animal feed pellets.

14. The composition of claim 1 wherein the pellets have a BTU of at least about 10,000 BTU per pound of pellets.

15. The composition of claim 1 wherein Camelina is Camelina sativa.

16. A method for preparing a composition of pellets comprising:
forming a pelletizable mixture from combustible biomass and oil-retaining seed mash wherein the pelletizable mixture comprises material derived from Camelina;
adding lubricant to the pelletizable mixture;
drying the mixture; and
pelleting the dried mixture to form the composition of pellets.

17. The method of claim 16 wherein the forming step comprises:
processing the combustible biomass;
extruding the oil-retaining seed mash;
breaking apart the extruded oil-retaining seed mash into fine particles; and
combining the processed biomass and the fine particles of the seed mash to form the pelletizable mixture.

18. The method of claim 17 wherein the processing of the combustible biomass comprises milling the biomass into fine particulates.

19. The method of claim 16 wherein the combustible biomass comprises Camelina stover.

20. The method of claim 16 wherein the lubricant is glycerol, glycerin or a combination thereof.

21. The method of claim 16 wherein the oil-retaining seed mash comprises Camelina seed mash.

22. The method of claim 16 wherein the combustible biomass further comprises soybean stover, corn stover, canola stover and combinations thereof.

23. The method of claim 16 wherein the oil-retaining seed mash further comprises canola seed mash.

24. The method of claim 16 wherein the combustible biomass is between about 40% and about 90% by weight of the pellet.

25. The method of claim 16 wherein the oil-retaining seed mash is between about 10% and about 40% by weight of the pellet.

26. The method of claim 16 wherein the lubricant is between about 0.01% and about 30% by weight.

27. The method of claim 16 wherein the adding step further comprises adding an essential oil.

28. The method of claim 16 wherein the drying step comprises drying the pelletizable mixture to a moisture content of between about 10% and about 20% by weight.

29. The method of claim 16 wherein Camelina is Camelina sativa.

30. A method for using byproducts from production of biofuels comprising:
forming a pelletizable mixture from combustible biomass and oil-retaining seed mash wherein the pelletizable mixture comprises material derived from Camelina;
adding lubricant to the pelletizable mixture;
drying the mixture; and
pelleting the dried product to form a composition of pellets.
